(19) United States
(12) Patent Application Publication
(10) Pub. No.: US 2024/0069549 A1
(43) Pub. Date: Feb. 29, 2024

(54) ISLAND/BORDER DISTINGUISHING FOR A ROBOT LAWNMOWER

(71) Applicant: Positec Power Tools (Suzhou) Co., Ltd., Suzhou (CN)

(72) Inventor: John HOFFMAN, Houghton, MI (US)

(21) Appl. No.: 17/900,462

(22) Filed: Aug. 31, 2022

(51) Int. Cl. G05D 1/02; A01D 34/00

(52) U.S. Cl. CPC G05D 1/0212; A01D 34/008; A01D 2101/00; G05D 2201/0208

(57) ABSTRACT

A robot lawn mower and computer implemented method is disclosed for distinguishing a type of feature in a lawn area. The method includes detecting a non-lawn feature in an upcoming path of the robot lawnmower, controlling the robot lawnmower to circumnavigate the non-lawn feature around a perimeter of the non-lawn feature, recording characteristics of the circumnavigation of the non-lawn feature, and distinguishing, based on the characteristics of the circumnavigation, a type of non-lawn feature as being either a boundary of a lawn area or a feature entirely contained within the lawn area.

### TECHNICAL FIELD

The present application relates to an apparatus, system and method for autonomously controlling a robot lawnmower, and in particular, for a robot lawnmower to distinguish a type of obstacle and/or boundary.

### BACKGROUND

A robot or robotic lawnmower is an autonomous robot configured to cut grass on a lawn or field. Having a robot lawnmower removes the need for a human to cut the grass themselves, which can be a mundane and burdensome task.

FIG. 1 shows an example of a lawn area that a robot lawnmower may operate in. The robot lawnmower 1 may be housed and charged at a charging station 2, and cut grass within a lawn area 3 designated by a boundary or guide wire 4. The boundary or guide wire 4 is required to be physically installed prior to activating the robot lawnmower 1. The robot lawnmower 1 detects the boundary wire 4 and changes course, usually in a random direction, to avoid it.

The use of boundary wire 4 is inefficient and requires a user to meticulously set it up along the perimeter of the lawn area 3, as well as any obstacles/hazards within the lawn area 3. This is a time consuming and laborious task. Furthermore, the boundary wire 4 needs to be maintained throughout the life of the robot lawnmower 1.

The course planning in which the robot lawnmower changes course in a random direction is also inefficient, as the random direction could be towards obstacles/hazards or another boundary. By using random directions in course planning, the robot lawnmower 1 may take longer to cut the lawn in the lawn are 3.

It has been appreciated that it would be beneficial to provide a robot lawnmower that does not require boundary wire and plans a path such that the robot lawnmower functions more efficiently.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides a method of controlling a robot lawnmower, the method comprising: detecting a non-lawn feature in an upcoming path of the robot lawnmower; controlling the robot lawnmower to at least partially circumnavigate the non-lawn feature around a perimeter of the non-lawn feature; recording one or more characteristics of the circumnavigation of the non-lawn feature; and distinguishing, based on the characteristics of the circumnavigation, a type of non-lawn feature as being either a boundary of a lawn area or a feature entirely contained within the lawn area.

The type of non-lawn feature, once distinguished, may be stored to a memory of the robot lawnmower such that path planning for mowing a lawn or moving in the lawn area, by the robot lawnmower, may take into account the position and/or type of distinguished non-lawn features in the lawn area. The robot lawnmower may partially circumnavigate the non-lawn feature to distinguish it, meaning it is not necessary to complete an entire lap of the perimeter of the non-lawn feature. It may also completely circumnavigate the non-lawn feature. The perimeter may be an inner perimeter in the case of a boundary, and an outer perimeter in the case of a feature entirely contained within the lawn area. The feature entirely contained within the lawn area may be an obstacle or hazard.

Preferably, the characteristics of circumnavigation include a time of circumnavigation.

Preferably, the time of circumnavigation is indicated by a timer of a predetermined length of time, the method further comprising: initiating the timer at a start time of controlling the robot lawnmower to circumnavigate the non-lawn feature around the perimeter of the non-lawn feature; and distinguishing the non-lawn feature as a boundary of the lawn area if the timer expires.

Using a time of circumnavigation and in particular a timer of a predetermined length in this manner can provide efficiency benefits. Circumnavigating a boundary of the lawn area can be a time-consuming task for the robot lawnmower if the lawn area is big. Automatically distinguishing the non-lawn feature as a boundary of the lawn area upon the expiry of the timer means that it is not necessary for the robot lawnmower to circumnavigate the entirety of the non-lawn feature.

Preferably, the method further comprises setting the predetermined length of time of the timer, by controlling the robot lawnmower to perform a calibration circumnavigation of a feature entirely contained within the lawn area, wherein the calibration circumnavigation includes: controlling the robot lawnmower to circumnavigate the feature entirely contained within the lawn area around its perimeter; recording a calibration time taken to circumnavigate the entirety of the feature entirely contained within the lawn area; and setting the predetermined length of time of the timer equal or greater than the calibration time.

By automatically calibrating the timer such that its length of time set as equal or greater than a calibration time taken to circumnavigate an obstacle or hazard, the timer can be automatically set to provide an efficient way of distinguishing the boundary of the lawn area. In particular, if the non-lawn feature that is used for calibration is the largest in size of the non-lawn features contained entirely within the lawn area, the timer can be set to a length of time greater than the time taken to circumnavigate the largest feature, guaranteeing that expiry of the timer indicates a boundary of the lawn area, whilst keeping the time of the timer low to maximize efficiency.

Preferably, the method further comprises: recording the time of circumnavigation starting from a start time of controlling the robot lawnmower to circumnavigate the non-lawn feature around its perimeter; dynamically comparing the time of circumnavigation that has elapsed since the start time to a time threshold; and distinguishing the non-lawn feature as a boundary of the lawn area if the time of circumnavigation that has elapsed is equal or greater than the time threshold.

This represents an alternative to the timer, whereby instead time since the start of circumnavigation can be compared, in real-time, to a time threshold.

Preferably, the method includes dynamically comparing the time of circumnavigation that has elapsed since the start time to a plurality of time thresholds, wherein each time threshold corresponds to a respective size of non-lawn feature; and distinguishing the type of non-lawn feature and the size of the non-lawn feature based on which of the plurality of time thresholds are exceeded during the circumnavigation of the non-lawn feature.

By using multiple thresholds, not only the type of non-lawn feature is distinguished, but it is also possible to distinguish a size of the non-lawn feature, within a range, based on between which of the time thresholds the robot lawnmower completes circumnavigation of the non-lawn feature.

Preferably, the time threshold is user-configurable or user-adjustable. The user may set the time threshold or thresholds and adjust them when, for instance, features of the lawn area are introduced, moved or modified.

Preferably, the characteristics of circumnavigation include a rotational direction, indicative of whether the circumnavigation is clockwise or anti-clockwise.

The rotational direction of circumnavigation describes the general turning direction of the robot lawnmower as it circumnavigates the non-lawn feature. Measuring this direction can be done using an inertial measurement unit (IMU) for example, which is quick and efficient. A further option for measuring this direction is the use of visual simultaneous localization and mapping (V-SLAM). With the use of a camera, a VSLAM algorithm or technology may be used to record the angle of rotation and thus the turning direction of the camera, based on the change in position of particular features in a series of images captured by the camera.

Preferably, the rotational direction is a cumulative rotational direction over the entirety of the circumnavigation of the non-lawn feature. This rotational direction describes the overall turning direction of the robot lawnmower as it circumnavigates the non-lawn feature in its entirety.

Preferably, the characteristics of circumnavigation include a grass prevalence direction originating from the robot lawnmower to a detected portion of the environment of the robot lawnmower including grass.

The grass prevalence direction may thus be determined by any sensor suitable for detecting one or more positions of grass and non-grass in the vicinity of the robot lawnmower. Although a grass prevalence direction is preferred, the invention may relate to any surface coverage feature other than grass, such as other vegetation and plants. One purpose of the grass prevalence direction is to aid in distinguishing the type of non-lawn feature as is set out below in further preferred features. As such, the fact that the prevalence direction is preferably with respect to grass is not a requirement of this disclosure. Other surface coverage features, including a material, or man-made feature, such as concrete or road, may also be used.

Preferably, the grass prevalence direction is directed to a portion of the environment of the robot lawnmower including a highest ratio of grass to non-grass.

Preferably, the method comprises periodically determining and recording, by the robot lawnmower, the grass prevalence direction, such that multiple grass prevalence directions are recorded.

Preferably, the grass prevalence direction is a substantially left or right direction relative to a forward motion of the robot lawnmower during circumnavigation of the non-lawn feature.

Preferably, distinguishing, based on the characteristics of the circumnavigation, a type of non-lawn feature comprises: if the rotational motion is indicative of a clockwise circumnavigation of the non-lawn feature: distinguishing the type of the non-lawn feature as a boundary of the lawn area if the grass prevalence direction is substantially directed to the right of the robot lawnmower relative to the forward motion of the robot lawnmower; and distinguishing the type of the non-lawn feature as a feature entirely contained within the lawn area if the grass prevalence direction is substantially directed to the left of the robot lawnmower relative to the forward motion of the robot lawnmower; and if the rotational motion is indicative of an anti-clockwise circumnavigation of the non-lawn feature: distinguishing the type of the non-lawn feature as a boundary of the lawn area if the grass prevalence direction is substantially directed to the left of the robot lawnmower relative to the forward motion of the robot lawnmower; and distinguishing the type of the non-lawn feature as a feature entirely contained within the lawn area if the grass prevalence direction is substantially directed to the right of the robot lawnmower relative to the forward motion of the robot lawnmower.

Preferably, the grass prevalence direction is determined by, during controlling the robot lawnmower to circumnavigate the non-lawn feature around the perimeter of the non-lawn feature: obtaining sensor data from a sensor of the robot lawnmower, wherein the sensor data represents information indicative of grass present in the environment of the robot lawnmower; processing the sensor data to determine the grass prevalence direction, wherein the grass prevalence direction indicates the direction from the robot lawnmower to the portion of the environment of the robot lawnmower indicated by the sensor data as having the most grass present of the environment of the robot lawnmower.

Preferably, the sensor data is an image obtained from a camera of the robot lawnmower; and wherein the processing the sensor data includes: segmenting the image into regions of grass and non-grass; and determining the grass prevalence direction as the relative direction from a position of the robot lawnmower in the image to the position of the segmented region of grass.

The method may thus use a robot lawnmower including a camera and an inertial measurement unit (IMU) for example, to detect the characteristics of the circumnavigation including the rotational direction and the grass prevalence direction respectively. Thus, the non-lawn feature may be distinguished using this method using relatively simple and inexpensive hardware. Alternatively the IMU is not required to detect the characteristics of circumnavigation, as these can instead be performed using VSLAM technology, by monitoring, recording and tracking features across a series of images captured by the camera.

Preferably the method further includes: capturing a plurality of images by the camera of the robot lawnmower; segmenting each image of the plurality of images into regions of grass and non-grass; determining a grass prevalence direction for each of the plurality of images to obtain a plurality of grass prevalence directions; and determining an overall grass prevalence direction from the plurality of grass prevalence directions; wherein distinguishing, based on the characteristics of the circumnavigation, the type of non-lawn feature comprises using the overall grass prevalence direction.

Using a plurality of measurements of the grass prevalence direction to form an overall grass prevalence direction increases the reliability of the method, and reduces the risk of wrongly distinguishing the non-lawn feature.

Preferably, the method further includes: generating a mapping from the plurality of images, including aggregating the regions of grass and non-grass from each of the plurality onto the mapping, to form one or more aggregate regions; determining a current location of the robot lawnmower on the mapping; determining a most grass region from the one or more aggregate regions; determining an exit direction from the current location of the robot lawnmower to the most grass region on the mapping; and, upon distinguishing the non-lawn feature to be a feature entirely contained within the lawn area: controlling the robot lawnmower to exit the perimeter of the non-lawn feature in the exit direction.

Using the same data collected for distinguishing the type of non-lawn feature to determine an exit direction is efficient, as it allows both of these tasks to be completed without the need of further sensors. Determining an exit direction after following the perimeter of the non-lawn feature, based on the most grass region also promotes lawn-mowing efficiency, since it is more likely that lawn can be cut without further interruption from obstacles upon exit from the perimeter of the non-lawn feature.

Preferably, the characteristics of circumnavigation further include a predetermined initial rotation direction in which the robot lawnmower is configured to turn after detecting the non-lawn feature.

Preferably, distinguishing, based on the characteristics of the circumnavigation, a type of non-lawn feature comprises: distinguishing the type of the non-lawn feature as a boundary of the lawn area if the predetermined initial rotation direction corresponds to substantially the same direction as the rotational direction; and distinguishing the type of the non-lawn feature as a feature entirely contained within the lawn area if the predetermined initial rotation direction is opposite to the rotational direction.

The type of non-lawn feature can thus be distinguished from several different characteristics of circumnavigation. Where multiple characteristics are used, the reliability of the distinguishing is increased.

Preferably, the method further includes, prior to controlling the robot lawnmower to circumnavigate the non-lawn feature around its perimeter, and substantially at the perimeter of the non-lawn feature, controlling the robot lawnmower to rotate in the predetermined initial rotation direction such that the robot lawnmower faces a direction tangential to the perimeter of the non-lawn feature; and controlling the robot lawnmower to circumnavigate the non-lawn feature around the perimeter of the non-lawn feature starting from the direction tangential to the perimeter of the non-lawn feature.

Preferably, the method further includes: controlling the robot lawnmower to completely circumnavigate the non-lawn feature around a perimeter of the non-lawn feature; and detecting that the robot lawnmower has circumnavigated the entirety of the non-lawn feature.

Preferably, the detecting that the robot lawnmower has circumnavigated the entirety of the non-lawn feature comprises: recording an initial orientation of robot lawnmower before controlling the robot lawnmower to circumnavigate the non-lawn feature around the perimeter of the non-lawn feature; and periodically recording an updated orientation of the robot lawnmower during the circumnavigation of the non-lawn feature; comparing the updated orientation of the robot lawnmower to the initial orientation of the robot lawnmower, until the comparing indicates that the robot lawnmower has circumnavigated the entirety of the non-lawn feature.

The orientation may be detected by the same sensor, such as an IMU, or the camera using VSLAM technology, as the rotational direction set out above. Therefore, the detection of complete circumnavigation of the non-lawn feature may be determined from data relating to the rotational direction.

Preferably, the initial orientation and the updated orientation correspond to an initial yaw value and an updated yaw value of the robot lawnmower respectively.

Preferably, the comparing indicates that the robot lawnmower has circumnavigated the entirety of the non-lawn feature when there is at least a three hundred and sixty degree difference between the initial yaw value and the updated yaw value.

Preferably, the method includes determining the rotational direction of the circumnavigation by comparing the initial orientation of the robot lawnmower to the updated orientation of the robot lawnmower.

In a second aspect, the present disclosure provides a computer readable medium having instructions stored thereon, which, when executed by a processor, cause the processor to perform the method of the first aspect.

In a third aspect, the present disclosure provides a computer program, which, when executed by a processor, causes the processor to perform the method of the first aspect.

In a fourth aspect, the present disclosure provides a robot lawnmower comprising a memory module, one or more sensors, and a processor communicatively coupled to the memory module and the one or more sensors, wherein the processor is configured to perform the method of the first aspect.

Preferably, the one or more sensors includes a camera configured to capture images of an upcoming path of the robot lawnmower.

Preferably, the one or more sensors further includes an inertial measurement unit for calculating a yaw value.

In a fifth aspect, the present disclosure provides a system comprising: the robot lawnmower of the fifth aspect, and a charging station for charging the robot lawnmower.

Parts of the method described herein may be performed by software in machine readable form on a tangible storage medium e.g. in the form of a computer program comprising computer program code adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

### BRIEF DESCRIPTION OF DRAWINGS

Embodiments of the invention will be described, by way of example, with reference to the following drawings, in which:

FIG. 1 is a schematic diagram illustrating an example of a lawn area in which a robot lawnmower may operate;

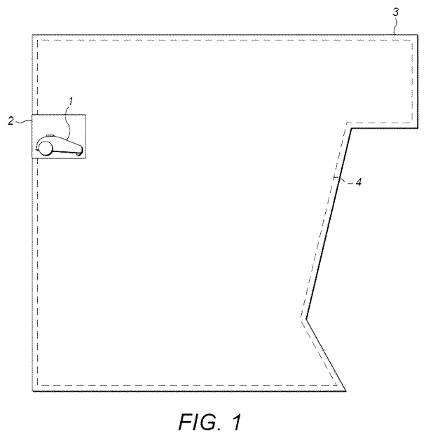

FIG. 2 is a schematic diagram illustrating an example of a lawn area in which the robot lawnmower according to an embodiment of the invention may operate;

FIG. 3 is a schematic diagram illustrating the robot lawnmower according to an embodiment of the invention;

FIG. 4 is a flow diagram illustrating a method of border following and non-lawn feature discrimination according to an embodiment of the present invention;

FIG. 5 is a flow diagram illustrating a second method of border following and non-lawn feature discrimination according to an embodiment of the present invention;

FIG. 6 is a flow diagram illustrating path-planning method according to an embodiment of the present invention;

FIG. 7 is a flow diagram illustrating a further path-planning method according to an embodiment of the present invention;

FIG. 8 illustrates a photograph of a typical obstacle and corresponding mapping showing areas of detected grass and non-grass; and

FIG. 9 shows a schematic diagram of a photograph of a typical obstacle and corresponding mapping showing areas of detected grass and non-grass with a planned path of escape from the obstacle, according to the present invention.

Common reference numerals are used throughout the figures to indicate similar features.

### DETAILED DESCRIPTION

Embodiments of the invention described below relate to an apparatus and method for controlling a small autonomous vehicle such as a robot lawnmower.

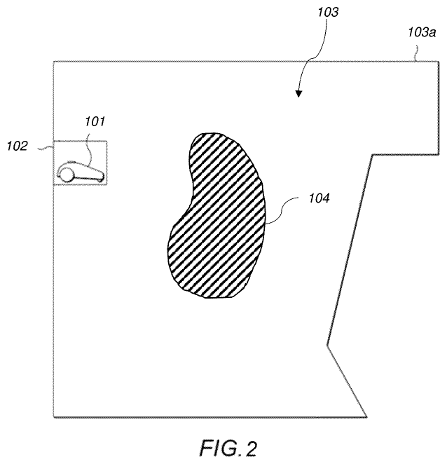

FIG. 2 shows a schematic overview of a robot lawnmower 101 according to an embodiment of the invention, within a typical lawn area 103. The lawn area 103 includes lawn (grass) and may include obstacles/hazards 104 contained therein. The robot lawnmower 101 is configured to cut the lawn (grass) within the lawn area 103, without exiting the lawn area 103 and without hitting/entering any obstacles/hazards 104. When the robot lawnmower 101 is inactive, it is configured to charge at a charging station 102. The lawn area 103 is not required to be delimited by a guide wire or boundary wire, because the robot lawnmower 101 is able to navigate the lawn area 103 without such features. The lawn area 103 is defined by a boundary 103a. The boundary 103a refers to the actual boundary of the lawn.

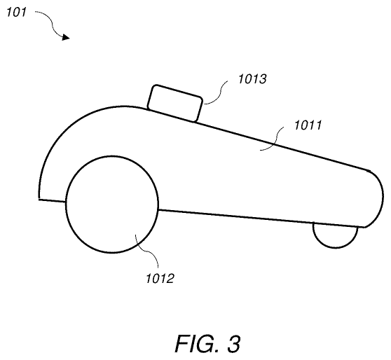

Embodiments of the invention include methods for detecting a non-lawn feature, distinguishing the non-lawn feature such that it is determined to be either an obstacle/hazard 104 or a boundary 103a of a lawn area 103, and controlling the robot lawnmower to avoid these features. FIG. 3 shows a schematic diagram of the robot lawnmower 101 according to the invention. The robot lawnmower 101 includes a body 1011, wheels 1012, a power source (not shown), a grass-cutting instrument (not shown), and a control module 1013. The robot lawnmower is preferably a differential drive robot, which allows the robot to turn with a turning radius of zero. This allows the robot lawnmower to turn in any scenario and helps to avoid the robot lawnmower 101 becoming stuck. The control module 1013 includes a computer, or processor configured to perform computations and execute software, and a memory. The control module 1013 includes or is otherwise in communication with one or more sensors. The one or more sensors are configured to provide the control module 1013 with information regarding lawnmower parameters, such as absolute/relative position of the robot lawnmower 101; absolute/relative position of obstacles and/or lawn area boundaries; absolute/relative position of the charging station 102; absolute/relative position of lawn within the lawn area 103 that has been recently cut or mown by the robot lawnmower 101; humidity; temperature; robot lawnmower kinematics; robot lawnmower power; and the like. Such sensors may include an Inertial Measurement Unit (IMU), a camera, a cadence sensor, a speed sensor, an accelerometer, a GPS sensor, an ultrasonic sensor, a radar, an infrared sensor, a laser-based sensor, LIDAR and the like. It is to be understood that the control module may include or be communicatively coupled with any or none of these types of sensors. The control module 1013 of the robot lawnmower 101 may further be configured to include and/or communicate with an imaging sensor such as a camera device. The imaging sensor is configured to capture images of the environment of the robot lawnmower, preferably in the upcoming forward path of the robot lawnmower. As will be understood, the imaging sensor has parameters such as a field of view and a maximum frame rate. A wide-angle camera device is preferred, such that the field of view includes at least partial side views as well as a forward or upcoming path view. The imaging sensor may be a Sony™ IMX 327 or IMX 390, for example, with a field of view of 130 degrees.

The imaging sensor is configured to routinely capture images corresponding to a forward view of the robot lawnmower 101, such that a stream of images illustrating the environment in front of the robot lawnmower 101, or otherwise in the upcoming path of the robot lawnmower 101, are captured. It is to be understood that, although a forward view is referred to here, a wide angle field of view may include images including a side view or rear view of the robot lawnmower.

The control module 1013 is configured to process each captured image using a semantic segmentation algorithm, to segment the captured image into areas or regions and identify these areas or regions as including grass or not including grass. The areas not including grass may be referred to as ‘non-lawn features’, where the robot lawnmower 101 is prevented from entering and/or activating the grass-cutting instrument. The semantic segmentation algorithm is applied to each captured image in the stream of captured images via software stored on a local memory coupled with the control module 1013. It is however to be understood that any one or more computer-implemented processes discussed herein may be performed remotely via a network, server or the like.

The semantic segmentation algorithm may be trained according to various techniques as will be understood. Application of the semantic segmentation algorithm on a captured image results in a segmented image, whereby the segmented image is split into different areas or regions. The areas or regions are then classified as grass or not grass.

An imaging sensor, together with an image segmentation algorithm as described above, may be used by the robot lawnmower to identify obstacles and boundaries, and is used in conjunction with a border-following process to provide the ability to differentiate or distinguish between obstacles and boundaries. In embodiments of the invention, the robot lawnmower 101 may thus be used to distinguish between a boundary 103a of the lawn area and an obstacle/hazard 104 located wholly within the boundary 103a. An obstacle/hazard 104 wholly within the boundary 103a may be considered to be an ‘island’ within the lawn area.

As noted above, the obstacle/hazard 104 or ‘island’ may be distinguished from the boundary 103a by using a border-following process. The border following process may form part of a more general path-planning algorithm for the robot lawnmower 101. The path planning algorithm describes how the robot lawnmower 101 is instructed to move within the lawn area 103 to cut grass and avoid boundaries 103a and obstacles/hazards 104.

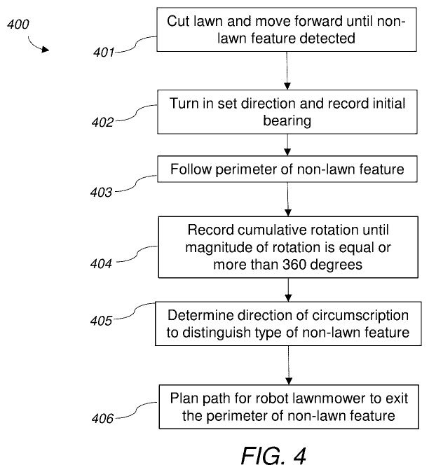

A first implementation of the border-following process is illustrated in FIG. 4, which shows a flow diagram 400.

In a first step 401, the robot lawnmower 101 is configured to cut lawn and move forwards in a simultaneous manner, until a non-lawn feature, such as an obstacle/hazard 104 or boundary 103a is detected in the upcoming path of the robot lawnmower 101. The detection of these features may be performed by any one or more sensors on the robot lawnmower 101, and/or by using the image processing discussed above. The determination that there is a non-lawn feature in the upcoming path of the robot lawnmower 101 arises from the determination that the area in front of the robot lawnmower 101 is ‘not grass’, either by using the image segmentation algorithm in the case that an imaging sensor is employed, or using other logic in the case that a different sensor is employed for detection. This determination does not distinguish the type of non-lawn feature which has been detected at this point. It is to be understood that, whilst in this example, the robot lawnmower 101 is said to be cutting grass, this is not a requirement and the robot lawnmower 101 may alternatively be moving without cutting grass, to return to the charging station 102 for instance.

In a second step 402, the robot lawnmower 101 is configured to continue to move towards the detected non-lawn feature until it reaches a minimum acceptable distance from the non-lawn feature. This minimum acceptable distance is configurable, and is set to prevent the robot lawnmower 101 from hitting, or otherwise encroaching on or past the non-lawn feature. Once the robot lawnmower 101 reaches the minimum acceptable distance, the robot lawnmower 101 is configured to rotate in a set direction and thereafter record an initial bearing of the robot lawnmower 101. The set direction may be right or left, for example, with respect to the non-lawn feature when the robot lawnmower 101 is initially facing the non-lawn feature. If the set direction is left, then, after reaching the minimum acceptable distance from the non-lawn feature, the robot lawnmower 101 is configured to turn left such that the robot lawnmower 101 is arranged adjacent to the non-lawn feature, in an orientation such that the forward direction of the robot lawnmower 101 is tangential to the non-lawn feature. The initial bearing may be recorded by any suitable sensor, such as an IMU or compass. In the case of an IMU, IMU yaw is recorded after the robot lawnmower has turned in the set direction, such that it is facing a tangential direction with respect to the non-lawn feature. The initial bearing is recorded to memory and stored on the robot lawnmower 101. For example, the initial bearing may be 60 degrees.

In a third step 403, the robot lawnmower 101 is configured to circumnavigate the perimeter of the non-lawn feature. To ensure that the robot lawnmower 101 is following the perimeter of the non-lawn feature, the robot lawnmower 101 is configured to maintain the minimum acceptable distance from the non-lawn feature. To aid in this process, the robot lawnmower 101 is configured to use the one or more sensors and/or the imaging sensor discussed above. In particular, the one or more sensors are used to measure a distance from the robot lawnmower 101 and/or an orientation with respect to the non-lawn feature. When an imaging sensor is used for this purpose, it may be ensured that frames captured by the imaging sensor include at least a portion of the non-lawn feature. In other words, it may be ensured that the non-lawn feature is present in the field of view of the imaging sensor. The imaging sensor may be fixed with respect to the robot lawnmower 101. In this case, the field of view of the imaging sensor is fixed with respect to the orientation of the robot lawnmower 101. This allows for real-world distances to be determined based on the distances between pixels in an image, as will be understood. In another example, an ultrasonic, infrared, or radar sensor is used to calculate the distance from the robot lawnmower 101 to the non-lawn feature as the robot lawnmower 101 follows the perimeter of the non-lawn feature. The presence of the non-lawn feature in frames captured by the imaging sensor, or the distance obtained from the one or more other sensors, is then used to inform control of the robot lawnmower in following the perimeter of the non-lawn feature. In particular, control of the robot lawnmower 101 in following the perimeter of the non-lawn feature may include detecting a virtual perimeter in the image or sensor data corresponding to the real-world perimeter of the non-lawn feature, determining the direction of the virtual perimeter, and adjusting the heading of the robot lawnmower 101 accordingly. Other methods of control, such as maintaining a set or predefined distance, and/or staying within a set or predefined distance of the detected non-lawn feature during circumnavigation may also be employed.

In a fourth step 404, the cumulative rotation of the robot lawnmower 101 as it circumnavigates the non-lawn feature is recorded. This is done by comparing or subtracting a present bearing from the initial bearing stored in memory. A present bearing may be recorded periodically by the robot lawnmower 101 until the magnitude of the cumulative difference between the present bearing and the initial bearing is equal or greater than 360 degrees. The direction of rotation is also recorded as part of the bearing recording. The direction of rotation may be determined using any suitable sensor. In an example, the direction of rotation is determined with the IMU sensor. For instance, when starting with a recording at a bearing of 60 degrees, if the perimeter of the non-lawn feature is followed until the value of IMU yaw reaches a cumulative 420 degrees, then this indicates a clockwise (or cumulatively right) rotation. If the cumulative IMU yaw reaches −300 degrees, this indicates an opposite, anti-clockwise (or cumulatively left) rotation. IMU yaw data may be periodically sampled and recorded during circumnavigation of the non-lawn feature to determine the cumulative rotational direction of the circumnavigation in this manner. Once the magnitude of cumulative rotation is detected as being 360 degrees (+360 degrees or −360 degrees), the method continues to a fifth step 405.

In the fifth step 405, the direction of the circumnavigation of the detected feature is firstly determined, based on the IMU data recorded in the fourth step 404. A negative rotation of −360 degrees indicates an anti-clockwise (or cumulatively left) rotation. A positive rotation indicates a clockwise (or cumulatively right) rotation. This information is then used with information indicating the initial set direction in which the robot lawnmower 101 rotates in the second step 402.

If the set direction is left, such that the robot lawnmower 101 is configured to turn left in the second step 402, then a clockwise circumnavigation of the detected feature indicates that detected feature is an obstacle/hazard 104 within and enclosed by the lawn area 103. In this instance, the detected feature represents an area where it is not possible to cut grass within the lawn area 103. This could be an obstacle/hazard 104 as illustrated in FIG. 2. Conversely, an anti-clockwise circumnavigation when the set direction is left indicates that the detected feature is an outer boundary 103a of the lawn area 103. In this case, the detected feature represents the edge of the lawn area 103, where the robot lawnmower 101 cannot cut grass past.

If the set direction is right in the second step 402, then a clockwise circumnavigation indicates that the detected feature is an outer boundary 103a of the lawn area 103. An anticlockwise circumnavigation using a right turn indicates that the detected feature is an obstacle/hazard 104 within and enclosed by the lawn area 103.

The robot lawnmower 101 thus uses knowledge of the set direction and knowledge of the cumulative rotation direction to distinguish the type of non-lawn feature.

At an optional sixth step 406, once the type of non-lawn feature has been determined as either an outer boundary 103 or an inner hazard/obstacle 104, a path is planned to exit the perimeter of the non-lawn feature. The relative position/area/perimeter of the non-lawn feature and/or the type of non-lawn feature (boundary 103a or obstacle 104) may be recorded to memory such that the robot lawnmower 101 is able to recognise the non-lawn feature and take its position and size into account when planning future paths for cutting grass in the lawn areas 103. More detail on the exit of the non-lawn feature perimeter is provided later in this description.

It is to be understood that, although the flow diagram 400 and the method it describes is explained with reference to the use of an IMU, the functions of the IMU set out above may be performed by one or more other sensors or technologies. For example, a camera device may be used in combination with VSLAM techniques or algorithms. The camera may capture a series of images, whereby the VSLAM algorithm records the cumulative rotation and the direction of circumnavigation of the robot lawnmower 101 based on the relative change in the position and/or orientation of features recorded and tracked through the series of images. It is to be understood that reference to a function of the IMU elsewhere in this description may also be replaced by the use of a camera employing the same or similar VSLAM techniques to determine rotation, position and orientation of the robot lawnmower 101.

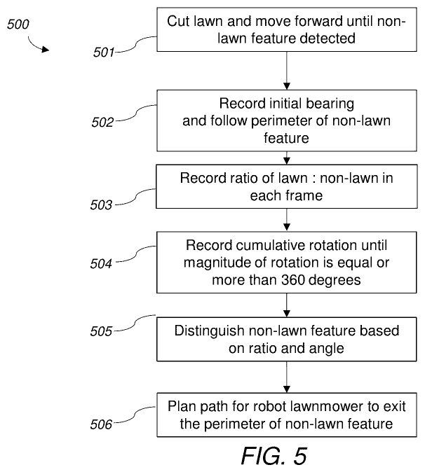

FIG. 5 shows a second implementation of the border-following process. The second implementation may be used as an alternative or in compliment with the first implementation set out above with respect to FIG. 4. The second implementation is similar to the first, and includes several of the same/similar steps. For completeness, these are set out below, as part of the following method 500.

In a first step 501, the robot lawnmower is configured to move forward until a non-lawn feature is detected. As with the first implementation set out with respect to FIG. 4, the non-lawn feature is of an unknown type at this stage, and may be a boundary 103a or an obstacle/hazard 104 contained wholly within the boundary 103a. The robot lawnmower may be cutting grass or moving without cutting grass. The non-lawn feature may be detected by the imaging sensor or any other sensor of the robot lawnmower. The robot lawnmower 101 is configured to continue to move towards the detected non-lawn feature until it reaches a minimum acceptable distance from the non-lawn feature. This minimum acceptable distance is configurable, and is set to prevent the robot lawnmower 101 from hitting, or otherwise encroaching on or past the non-lawn feature.

In a second step 502, the robot lawnmower is configured follow the perimeter of the non-lawn feature, maintaining the minimum acceptable distance. As noted above with respect to the first implementation in the second step 402, this may be performed using the imaging sensor. In particular, the robot lawnmower may be instructed to turn so as to keep at least a portion of the non-lawn feature within the field of view of the imaging sensor after the imaging sensor has detected the non-lawn feature in the first step 501. It is to be understood that detection and tracking of the non-lawn feature throughout different frames and viewpoints of the imaging sensor may be performed using standard image processing and computer vision algorithms. For example, if non-lawn feature is initially visible in the right hand side of the field of view of the imaging sensor, the robot lawnmower may be configured to rotate gradually as it follows the perimeter such that the detected non-lawn feature is maintained in a right hand side of the field of view of the imaging sensor. It is to be understood that other sensors, such as those that can deduce a distance between the robot lawnmower 101 and the non-lawn feature, may be used to aid in the following of the perimeter of the non-lawn feature. It is noted that, unlike the first implementation described above in the method 400, the second implementation does not require the robot lawnmower 101 to initially turn in a set direction. In this implementation, the robot lawnmower may turn in any initial direction, in order to face a tangential direction with respect to the non-lawn feature to start perimeter following.

Before following the perimeter of the non-lawn feature, the robot lawnmower 101 is configured to record an initial orientation, bearing or angle of the robot lawnmower 101. This may be done using an IMU sensor, by recording IMU yaw at the start of the circumnavigation. For instance, an initial recording may be a bearing of 60 degrees. The initial bearing is recorded to memory and stored on the robot lawnmower 101.

In a third step 503, the robot lawnmower 101 is configured to continuously record the ratio of grass:non-grass on the left and right sides of a stream of consecutive images recorded by the imaging sensor, as the robot lawnmower 101 circumnavigates the perimeter of the non-lawn feature. The ratios may be recorded per frame in a reference database. The ratio of grass:non grass may be determined using similar computer vision techniques as set out above, including image segmentation and classification. In particular, each image captured by the imaging sensor may be segmented into grass/non grass regions, and the ratio of these regions is then recorded. Two ratios may be recorded per frame: a first ratio of grass:non-grass corresponding to a left hand side half of a captured frame and a second ratio of grass:non-grass corresponding to a right hand side half of a captured frame. Values for each of these first and second ratios are recorded in the reference database per frame. For example, at frame no. 2, the first ratio of grass:non-grass may be 5, and the second ratio of grass:non-grass may be 0.5. These values would indicate that more grass is found in the left hand side of the frame when compared to the right hand side. Although a ratio or a first and second ratio is described here, it is to be understood that any comparison mechanism or logic may be used to post-process the captured images to determine whether grass is more prevalent in the left hand side or right hand side of a captured frame. For example, image post-processing techniques may return a result simply indicating right or left (R or L), corresponding to the side of most grass. The indicators R or L may then be stored in the reference database according to the corresponding frame number. Preferably, the ratio may be used to determine a grass prevalence direction, whereby, if the ratio indicates that grass is more prevalent on the right hand side of an image, for example, the grass prevalence direction is from the position of the robot lawnmower to the right hand side of the image.

In a fourth step 504, the cumulative angle of rotation of the robot lawnmower 101 is recorded as the robot lawnmower circumnavigates the perimeter of the non-lawn feature. The cumulative angle of rotation may be described as a rotational direction (e.g. clockwise or anticlockwise). This may be detected with the IMU sensor used to record the initial orientation/bearing/angle of the robot lawnmower 101 as noted in the second step 502. The calculation of the cumulative rotation is done by comparing or subtracting a present bearing from the initial bearing stored in memory. A present bearing may be recorded periodically by the robot lawnmower 101 until the magnitude of the cumulative difference between the present bearing and the initial bearing is equal or greater than 360 degrees. The direction of rotation is also recorded as part of the bearing recording. The direction of rotation may be determined using any suitable sensor. In an example, the direction of rotation is determined with the IMU sensor. For instance, when starting with a recording at a bearing of 60 degrees, if the perimeter of the non-lawn feature is followed until the value of IMU yaw reaches a cumulative 420 degrees, then this indicates a clockwise (or cumulatively right) rotation. If the cumulative IMU yaw reaches −300 degrees, this indicates an opposite, anti-clockwise (or cumulatively left) rotation. IMU yaw data may be periodically sampled and recorded during circumnavigation of the non-lawn feature to determine the cumulative rotational direction of the circumnavigation in this manner. Once the magnitude of cumulative rotation is detected as being 360 degrees (+360 degrees or −360 degrees), the method continues to a fifth step 505.

In a fifth step 505, the robot lawnmower 101 is configured to distinguish the non-lawn feature as either an outer boundary 103a of the lawn area 103 or an ‘island’ hazard/obstacle 104 contained within the lawn area 103. To do this, the robot lawnmower 101 uses information concerning the cumulative rotational direction from the fourth step 504, and information from the reference database concerning the prevalence of grass/non-grass in the left or right hand side of recorded frames, or the grass prevalence directions. If recorded ratios or L and R direction indicators, for example, stored in the reference database consistently indicate that non-lawn is greater on the side of the robot lawnmower in which the robot lawnmower gradually turns according to the cumulative rotational direction to circumnavigate the non-lawn feature, it is determined that the non-lawn feature is an obstacle/hazard and island. In other words, if the grass prevalence directions are consistently pointing away from the center of rotation indicated by the cumulative rotational direction, then the non-lawn feature is distinguished as an island obstacle/hazard. On the other hand, if the grass prevalence directions are consistently pointing substantially toward the center of rotation, the non-lawn feature is distinguished as a boundary 103a.

For example, if the robot lawnmower gradually turns left (anti-clockwise) around the perimeter of the non-lawn feature, as indicated by the direction of rotation during circumnavigation from IMU yaw data, and the recorded ratios or L and R indicators in the reference database consistently indicate that areas of non-lawn are more prevalent on the left hand side of captured images, it is the case that the robot lawnmower is navigating around an outer perimeter of an island obstacle/hazard 104 within the lawn area 103.

When the recorded ratios consistently indicate that non-lawn is greater on the side of the robot lawnmower which is opposite the side to which the robot lawnmower gradually turns according to the cumulative rotational direction to circumnavigate the non-lawn feature, it is determined that the non-lawn feature is an outer boundary 103a of the lawn area 103.

In other words, when there is a correspondence between the turning direction during circumnavigation, and the direction in which non-grass is most prevalent from the recorded ratios in the reference database, the non-lawn feature is distinguished as an island obstacle/hazard 104. Conversely, when there is not a correspondence between the turning direction during circumnavigation, and the direction in which non-grass is most prevalent from the recorded ratios, the non-lawn feature is distinguished as a boundary 103a of the lawn area. For example, if the IMU yaw data indicates a cumulative angular change of −360 degrees from an initial bearing, this means that the robot lawnmower has turned in an anticlockwise direction, indicating a cumulative left turn. If the recorded ratios also indicate that non-lawn is more prevalent in the left hand side of frames, it follows that the robot lawnmower has been circumnavigating the outside perimeter of an island obstacle/hazard 104. Conversely, if the IMU yaw data indicates a cumulative angular change of +360 degrees from an initial bearing, this means that the robot lawnmower has turned in an clockwise direction, indicating a cumulative right turn. If the recorded ratios also indicate that non-lawn is more prevalent in the left hand side of frames, it follows that the robot lawnmower has been circumnavigating the inner perimeter of a boundary 103a of the lawn area 103.

The prevalence of non-lawn or the prevalence of lawn (i.e. the presence of non-grass or the prevalence of grass) may be used according to the method 500. Using a grass prevalence direction rather than a non-grass prevalence direction means the inverse of the logic above is applied, as will be understood.

Furthermore, it is to be understood that the rotational direction is only required to be recorded in method 500 if the ratios of grass: non-grass recorded in the third step 503 do not provide absolute direction data. In other words, the recording of an initial bearing or direction in the second step 502 and the recording of the rotational direction in the fourth step 504 are required for when the ratios of grass: non grass or the grass prevalence directions are only relative to the orientation of the robot lawnmower 101. For example, if the ratios record L or R direction indicators, the orientation of the robot lawnmower 101 is required to determine which direction is left and right with respect to the non-lawn feature.

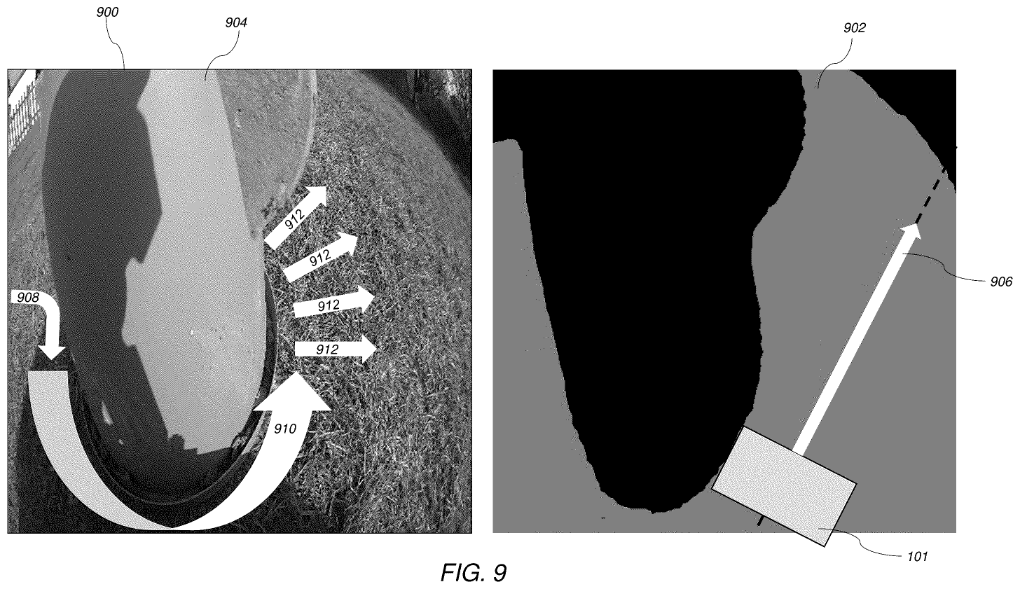

In some examples, the recording of the ratios of grass: non grass includes recording an absolute bearing in the direction of prevalence of grass/non-grass. In this case, it is possible to distinguish the type of non-lawn feature by accumulating each recorded bearing and determining whether they point internally or externally with respect to the path followed by the robot lawnmower as it follows the perimeter of the non-lawn feature. If the bearings of grass prevalence cumulatively indicate an internal direction, the non-lawn feature may be distinguished as a boundary 103a. If the bearings of grass prevalence cumulatively indicate external directions, the non-lawn feature may be distinguished as an island obstacle/hazard 104. For example, FIG. 9 shows grass prevalence directions 912 that point externally with respect to a path followed by the robot lawnmower 101.

The determination of whether grass/non-grass is more prevalent in one side of the captured frames compared to the other side may be performed in several different ways. For example, a winner-takes-all approach may be employed, whereby the number of left-side prevalent side frames are compared to the number of right-side prevalent frames with respect to either grass or non-grass. The higher number of these two dictates the overall prevalence. Alternatively, the recorded ratios may be averaged to determine an average ratio from which prevalence can be determined. It is understood that other techniques may be used for determining prevalence, and the method may work by detecting and focusing on the prevalence of areas of non-grass rather than the areas of grass.

In an optional sixth step 506, once the type of non-lawn feature has been determined as either an outer boundary 103 or an inner hazard/obstacle 104, a path is planned to exit the perimeter of the non-lawn feature. The relative position/area/perimeter of the non-lawn feature and/or the type of non-lawn feature (boundary 103a or obstacle 104) may be recorded to memory such that the robot lawnmower 101 is able to recognise the non-lawn feature and take its position and size into account when planning future paths for cutting grass in the lawn areas 103. More detail on the exit of the non-lawn feature perimeter is provided later in this description.

The first and second implementations of the border-following process are thus similar. The second implementation set out above with respect to FIG. 5, however, does not require the robot lawnmower 101 to move in a set direction, and instead uses sensor data such as images from an imaging sensor to determine the relative position of grass and non-grass with respect to the cumulative rotational direction to determine whether a detected non-lawn feature is a boundary 103a or an obstacle 104.

It is to be understood that the method 400 and the method 500 may be combined to provide three parameters (cumulative rotational direction, initial set direction, and ratio data) for the purposes of distinguishing a type of non-lawn feature. Having three parameters such as this introduces a redundancy to the method which makes it more reliable.

As a further option, upon starting the following of the perimeter of the non-lawn feature in either method 400 or 500, the robot lawnmower 101 may start a timer. The timer is configured to time the border-following process, including the formation of any mapping of grass and non-grass areas. If the timer exceeds a maximum threshold, the robot lawnmower 101 may perform an action. The action may include distinguishing the non-lawn feature based on the timer. For example, the timer may be two minutes, such that, if the border following process exceeds two minutes, the robot lawnmower may distinguish, upon the expiry of the two minute timer, that the non-lawn feature is a boundary 103a of the lawn area 103. Having a timer which operates in this way makes the border-following process more efficient, since the robot lawnmower 101 is not required to circumnavigate the entire boundary 103a to distinguish it. The timer may be a thirty seconds, one minute, two minute or five minute timer for example. The timer may be set dependent on the predetermined speed of the robot lawnmower 101. The timer may also be set based on a predefined maximum inner obstacle/hazard perimeter length, such that the timer is configured to expire at a time once this length has been travelled by the robot lawnmower travelling at the predetermined speed. The timer may be configurable by a user, such that the user can set the timer based on the relative size of obstacles and hazards 104 in a particular lawn area 103. In this way, the timer expires shortly after a time period taken to circumnavigate a largest obstacle/hazard 104 in the lawn area.

The timer may also be set automatically during a calibration procedure performed automatically by the robot lawnmower 101. In this calibration procedure, the robot lawnmower 101 may be positioned, by a user for example, to face or otherwise be adjacent to a largest obstacle/hazard 104 in the lawn area 103. The robot lawnmower 101 may then perform the border following process 400 or 500. During this calibration, the time taken to completely circumnavigate the largest obstacles/hazard 104 is recorded and stored, such that the robot lawnmower 101 has a reference time for the largest obstacle/hazard 104 in the lawn area 103. The timer according to this reference time. For example, the timer may be set equal to the sum of the reference time and a buffer time, wherein the buffer time is an additional time that ensures the largest hazard/obstacle 104 can be circumnavigated before the expiry of the timer. The buffer time may be 5, 10, or 30 seconds, for example.

Expiry of the timer may cause the robot lawnmower to exit the distinguished boundary 103a in the region of most grass, when a mapping of grass and non-grass areas is generated as discussed above.

Although a timer and the expiry thereof is discussed here, it is to be understood that alternatively, a time taken to circumnavigate may be recorded. The recorded time taken may then be dynamically compared to one or more thresholds, whereby the thresholds indicate or otherwise distinguish a class of obstacles/hazard (e.g. small/medium/large) and/or a boundary 103a. If the threshold corresponding to a boundary 103a is passed by the recorded time, the robot lawnmower 101 may end the border-following process 400 or 500 as indicated above, to maximize efficiency of performing non-lawn feature distinguishing.

As a further option, an ‘initial position’ of the robot lawnmower 101 may be recorded and stored in memory by the control module 1013, at the start of each perimeter-following operation performed in the above methods. The initial position may be the absolute position of the robot lawnmower 101, or the position of the robot lawnmower relative to the detected non-lawn feature. The position may be recorded through use of a GPS sensor and the like, or by recording the relative position with respect to the position of other features of the robot lawnmower environment. For example, the robot lawnmower 101 may be in communication with the charging station 102, and store a distance and bearing from the charging station 102 to the current position of the robot lawnmower 101.

The initial position may be used at the end of each method to verify that the robot lawnmower 101 has circumnavigated the non-lawn feature in its entirety, since the robot lawnmower 101 will arrive at the same position after completing a lap of the non-lawn feature. This means that the robot lawnmower 101 will follow the perimeter of the non-lawn feature in until it automatically circumnavigates the entire non-lawn feature in a movement pattern that includes three hundred and sixty degrees of rotation cumulatively, before arriving back at the recorded initial position.

At this moment, the robot lawnmower 101 is configured to recognize or match its current position to the recorded initial position of detection, to verify that the non-lawn feature has been circumnavigated. The matching of the current position to the initial position may be performed using the same of the one or more sensors used to recorded and store the initial position to memory. This may be done using a location-related sensor such as a GPS sensor.

In the case of using the imaging sensor for this purpose, image processing may occur at predetermined intervals to compare images captured by the imaging sensor at interval positions to an image taken from the initial position. At each interval, each image is compared with the initial image until a match or high similarity between images is determined. Verification of returning to the initial position may additionally require that the robot lawnmower 101 be in the same orientation or bearing as recorded at the initial position. This may be determined using a compass or IMU for example.

Once one or more boundaries 103a and/or obstacles 104 have been identified,

Once the non-lawn feature has been distinguished by the method 400 or the method 500, the type of non-lawn feature may be recorded in memory and its position stored. The position of the non-lawn feature may be stored relative to a reference point, such as the charging station 102, or absolutely, based on a positioning sensor such as a GPS sensor for example. A path may be planned for the robot lawnmower to cover and cut the entire lawn area 103 based on the position of detected and distinguished non-lawn features. The path is modified if further obstacles/hazards are detected within and enclosed by the lawn area 103. The path may be modified by repeating the method 400 or 500 with respect to the newly detected obstacle/hazard contained within the lawn area 103, and subsequently determining a new path in light of the detected obstacles/hazards.

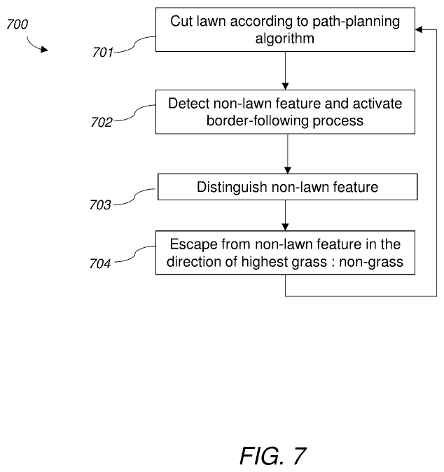

How the border-following process set out above relates to the overall function of the robot lawnmower 101 and path-planning will now be described with reference to FIGS. 7 to 9.

The border-following process forms part of a more general path planning algorithm, that is used to instruct the robot lawnmower 101 how to move and/or cut grass. The path planning algorithm may be implemented over software or a computer program stored on a memory of the robot lawnmower and executed by a processor of the robot lawnmower 101. The memory and processor may form part of the control module 1013.

The path planning algorithm includes instructions or logic to cause the robot lawnmower 101 to cut grass in the lawn area 103, and to return to the charging station 102. These behaviours represent two modes of operation of the robot lawnmower 101: a first mode wherein the robot lawnmower 101 is instructed to actively cut grass in the lawn area 103; and a second mode wherein the robot lawnmower 101 is instructed to return to stop cutting grass and return to the charging station 102. Whether or not the robot lawnmower 101 is in the first mode or the second mode may depend on parameters such as battery life and/or time of day. For example, when the robot lawnmower 101 is under a threshold battery level, or whereby the time of day reaches a threshold time, it may be put into the second mode by the control module 1013, thereby instructing the robot lawnmower 101 to stop cutting grass and return to the charging station 102.

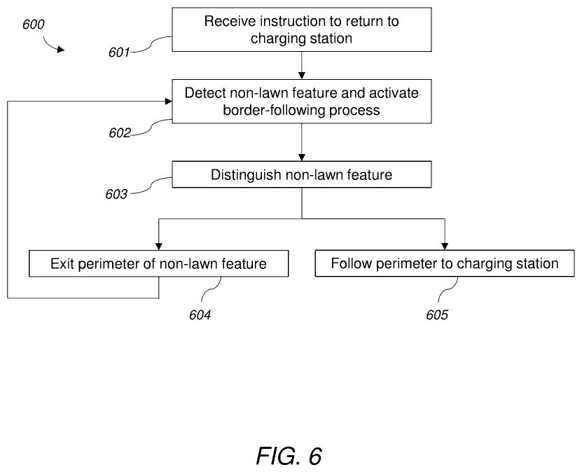

FIG. 6 shows a flow diagram of a method 600 corresponding to the second mode of operation. In this second mode, the path planning algorithm instructs the robot lawnmower 101 to return to the charging station 102.

In a first step 601, the robot lawnmower 101, receives an instruction to return to the charging station 102. This instruction is enacted by the control module 1013. The instruction, when executed, causes the robot lawnmower 101 to stop cutting grass and to travel to the boundary 103a of the lawn area 103. The location of the boundary 103a may not be stored or known to the robot lawnmower 101, so the direction of travel may be random. In this regard, a large memory module or GPS/location data is not required, since the robot lawnmower 101 does not need to store location data relating to the boundary 103a or the charging point 102.

In a second step 602, the robot lawnmower 101 detects, via one or more sensors such as the imaging sensor, a non-lawn feature in the path of the robot lawnmower 101. Upon detection of the non-lawn feature, the border-following process as explained above with reference to FIGS. 4 and 5 is activated. This may be performed by the control module 1013. This causes the robot lawnmower 101 to undertake the method as described above, and as shown in FIGS. 4 and 5.

In a third step 603, the result of the border following process is determined in that the non-lawn feature is distinguished as being an ‘island’ obstacle or hazard 104, or a boundary 103a of the lawn area 103. If the non-lawn feature is determined to be an ‘island’ obstacle/hazard 104, the method moves to a fourth step 604. If the non-lawn feature is determined to be the boundary 103a of the lawn area 103, the method moves to a fifth step 605.

In a fourth step 604, the robot lawnmower 101 is instructed and configured to exit the boundary following-process and thus exit the perimeter of the island obstacle/hazard 104. The robot lawnmower 101 may exit in a random direction, or alternatively, the robot lawnmower 101 may store an initial bearing or direction upon detection of the on-lawn feature in the second step 602, and continue in the initial bearing or direction when exiting the perimeter of the non-lawn feature in the fourth step 604. In order to ensure that the initial bearing or direction is traversable by the robot lawnmower 101, the robot lawnmower is configured to rotate in the initial bearing and observe the upcoming (forward) environment using the one or more sensors such as the imaging sensor, to ensure that the path in the initial bearing or direction is clear of the non-lawn feature. If this bearing or direction is not clear, the robot lawnmower 101 is configured to continue in the border-following process until the bearing or direction becomes clear. The robot lawnmower 101 may thus periodically check whether the bearing or direction is clear.

Once the robot lawnmower 101 has escaped from the perimeter of the non-lawn feature, the method then returns to the second step 602 when the robot lawnmower 101 detects a further non-lawn feature.

In the fifth step 605, after determining that the non-lawn feature is the boundary 103a of the lawn area 103, the robot lawnmower 101 is instructed and configured to continue to follow the perimeter of the boundary 103a of the lawn area 103 to reach the charging station 102. The robot lawnmower 101 may detect the presence of the charging station 102, or vice versa, using any suitable technique or instrument. For example, the robot lawnmower 101 may include a charging station detection sensor, such as a radio frequency identification (RFID) tag, and/or similarly, the charging station 102 may include an RFID tag. The robot lawnmower 101 and/or the charging station 102 may also include a sensor configured to detect contact from the other of the robot lawnmower 101 and the charging station 102.

FIG. 7 shows a flow diagram of a method 700 corresponding to the first mode of operation. In this first mode, the path planning algorithm instructs the robot lawnmower 101 to cut grass in a path in the lawn area 103.

At a first step 701, the robot lawnmower 101 is instructed to cut grass in a path that is formed or set by a path planning algorithm implemented in software in the control module 1013. The path planning algorithm may comprise a general path-planning algorithm, such as an algorithm that randomly selects a path for the robot lawnmower 101 to cut grass. The path planning algorithm does however further include the border following process according to any or both of FIGS. 4 and 5 as described above.

At a second step 702, a non-lawn feature is detected in the upcoming path of the robot lawnmower by the one or more sensors of the robot lawnmower 101, and the border following process is activated in response. The robot lawnmower is at this point, configured to execute the border-following process as set out above according to the first or second implementation.

In a third step 703, the result of the border following process is determined in that the non-lawn feature is distinguished as being an ‘island’ obstacle or hazard 104, or a boundary 103a of the lawn area 103.

In a fourth step 704, once the type of non-lawn feature is distinguished as either an outer boundary 103a or an ‘island’ obstacle 104, the robot lawnmower 101 is configured to leave the perimeter of the non-lawn feature. The robot lawnmower 101 may leave the perimeter at any suitable point. However, is more efficient for the purposes of cutting grass in the first mode of operation, that the robot lawnmower 101 leave the perimeter in a tangential direction of ‘most grass’. This means that the robot lawnmower 101 leaves the perimeter in a direction in which the most areas of ‘grass’ have been detected during the border-following process around the perimeter of the non-lawn feature.

In order to determine this direction, whilst the robot lawnmower 101 is circumnavigating the non-lawn feature during implementations of the border-following process as discussed above, the robot lawnmower 101 may detect and determine areas of grass and non-grass within the field of view of the imaging sensor. This occurs in the third step 503 of the method 500. Since the imaging sensor provides a forward-looking view, each frame captured by the imaging sensor effectively captures a view of the environment of the non-lawn feature that is tangential to the perimeter of the non-lawn feature. The robot lawnmower 101 may, for each frame captured during travel around the perimeter of the non-lawn feature, record areas of grass and non-grass and combine these areas across the stream of frames to create a mapping surrounding the non-lawn feature. The mapping shows the surroundings of the non-lawn feature. It is to be understood that the detection of grass and non-grass areas in these surroundings may be performed using standard image segmentation and classification techniques as discussed above.

After the type of non-lawn feature has been distinguished, the robot lawnmower is configured to determine the area of the stored mapping that has the highest proportion of grass, or otherwise the highest grass: non grass ratio. The robot lawnmower 101 may then be directed to leave the perimeter of the non-lawn feature in a direction towards that determined area. If the area is obstructed by the non-lawn feature, the robot lawnmower 101 may be instructed to continue to follow the perimeter of the non-lawn feature according to the border-following process until the area is reachable in a straight line by the robot lawnmower. Alternatively, the robot lawnmower may be configured to exit the perimeter of the non-lawn object towards the area of most grass that is directly reachable in a straight line from the current position of the robot lawnmower 101. By directing the robot lawnmower 101 to the area of most grass, the efficiency of the lawnmower is increased, as there is less likely to be regular interruptions from further non-lawn features, and more grass is likely to be cut in a shorter period of time.

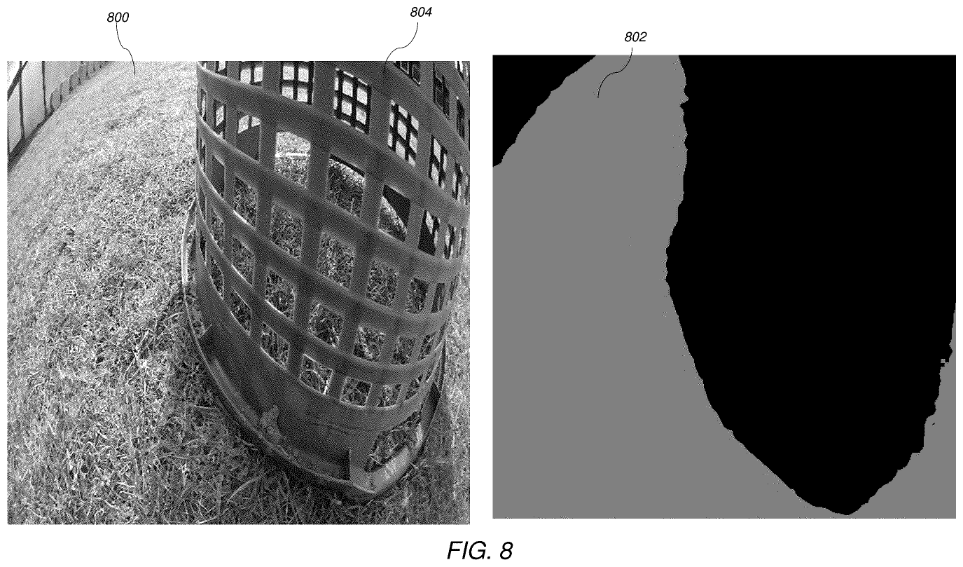

FIG. 8 shows an example photograph 800 of an obstacle 804 and a corresponding grass and non-grass region mapping 802.

FIG. 9 shows a second example photograph 900 of an obstacle 904 and a corresponding grass and non-grass region mapping 902. A schematic drawing of the robot lawnmower 101 is overlaid on the mapping 902. An arrow 906 indicates the direction from the robot lawnmower 101 to the area of the mapping including the most grass or the highest grass: non-grass ratio.

FIG. 9 also illustrates example directions that are used in the methods 400 and 500. in particular, FIG. 9 shows an initial rotation direction 908, an rotational direction of circumnavigation 910, and several recorded grass prevalence directions 912. It is to be understood that the grass prevalence directions 912 could be non-grass prevalence directions, in which case the direction of the arrows 912 in FIG. 9 would be opposite.

In the example of FIG. 9, the initial rotation direction 908 is in the opposite direction to the rotational direction of circumnavigation 910. The initial rotation direction 908 is a clockwise rotation whereas the rotational direction of circumnavigation 910 is anti-clockwise. According to method 400, this means that the non-lawn feature 904 is distinguished as an obstacle/hazard.

The grass prevalence direction 912 consistently radiates away from the centre of rotation of the rotational direction 910. This indicates an obstacle/hazard according to the method 500. If the grass prevalence direction is recorded as a grass: non grass ratio or L and R indicators, in the example of FIG. 9, the grass prevalence direction would be consistently indicated by a high ratio in the right hand side of images or consistent R direction indicators.

The methods and robot lawnmower 101 described herein thus provide a way of both distinguishing a type of non-lawn feature, and a way of leaving or escaping the non-lawn feature so as to maximise the cutting of grass. Distinguishing the type of non-lawn feature and recording the result helps to provide the robot lawnmower 101 with information regarding its environment which can then be used in path planning and charging station return operations. A benefit of these methods is that each of them can be performed without complex sensors. In particular, each of the above methods can be performed with an imaging sensor and/or an IMU.

In the described embodiments of the invention the control module 1013 may be implemented as any form of a computing and/or electronic device. It is to be understood that, although reference is made above to the control module 1013 of the robot lawnmower 101 being responsible for the methods described herein, these methods may be performed or computed via interaction with an external server, computer or satellite in communication with the robot lawnmower 101.

The robot lawnmower includes a computing and/or electronic device that may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The method may be stored as computer executable instructions an may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of controlling a robot lawnmower, the method comprising:
detecting a non-lawn feature in an upcoming path of the robot lawnmower;
controlling the robot lawnmower to at least partially circumnavigate the non-lawn feature around a perimeter of the non-lawn feature;
recording one or more characteristics of the circumnavigation of the non-lawn feature;
distinguishing, based on the characteristics of the circumnavigation, a type of non-lawn feature as being either a boundary of a lawn area or a feature entirely contained within the lawn area.

2. The method of claim 1, wherein the characteristics of circumnavigation include a rotational direction, indicative of whether the circumnavigation is clockwise or anti-clockwise.

3. The method of claim 2, wherein the rotational direction is a cumulative rotational direction over the entirety of the circumnavigation of the non-lawn feature.

4. The method of claim 3, wherein the characteristics of circumnavigation include a grass prevalence direction originating from the robot lawnmower to a detected portion of the environment of the robot lawnmower including grass.

5. The method of claim 4 wherein the grass prevalence direction is a substantially left or right direction relative to a forward motion of the robot lawnmower during circumnavigation of the non-lawn feature.

6. The method of claim 5, wherein distinguishing, based on the characteristics of the circumnavigation, a type of non-lawn feature comprises:
if the rotational motion is indicative of a clockwise circumnavigation of the non-lawn feature:
distinguishing the type of the non-lawn feature as a boundary of the lawn area if the grass prevalence direction is substantially directed to the right of the robot lawnmower relative to the forward motion of the robot lawnmower; and
distinguishing the type of the non-lawn feature as a feature entirely contained within the lawn area if the grass prevalence direction is substantially directed to the left of the robot lawnmower relative to the forward motion of the robot lawnmower; and
if the rotational motion is indicative of an anti-clockwise circumnavigation of the non-lawn feature:
distinguishing the type of the non-lawn feature as a boundary of the lawn area if the grass prevalence direction is substantially directed to the left of the robot lawnmower relative to the forward motion of the robot lawnmower; and
distinguishing the type of the non-lawn feature as a feature entirely contained within the lawn area if the grass prevalence direction is substantially directed to the right of the robot lawnmower relative to the forward motion of the robot lawnmower.

7. The method of claim 6, wherein the grass prevalence direction is determined by, during controlling the robot lawnmower to circumnavigate the non-lawn feature around the perimeter of the non-lawn feature:
obtaining sensor data from a sensor of the robot lawnmower, wherein the sensor data represents information indicative of grass present in the environment of the robot lawnmower;
processing the sensor data to determine the grass prevalence direction, wherein the grass prevalence direction indicates the direction from the robot lawnmower to the portion of the environment of the robot lawnmower indicated by the sensor data as having the most grass present of the environment of the robot lawnmower.

8. The method of claim 3 wherein the characteristics of circumnavigation further include a predetermined initial rotation direction in which the robot lawnmower is configured to turn after detecting the non-lawn feature.

9. The method of claim 8 wherein distinguishing, based on the characteristics of the circumnavigation, a type of non-lawn feature comprises:
distinguishing the type of the non-lawn feature as a boundary of the lawn area if the predetermined initial rotation direction corresponds to substantially the same direction as the rotational direction; and
distinguishing the type of the non-lawn feature as a feature entirely contained within the lawn area if the predetermined initial rotation direction is opposite to the rotational direction.

10. The method of claim 9, further comprising:
prior to controlling the robot lawnmower to circumnavigate the non-lawn feature around its perimeter, and substantially at the perimeter of the non-lawn feature, controlling the robot lawnmower to rotate in the predetermined initial rotation direction such that the robot lawnmower faces a direction tangential to the perimeter of the non-lawn feature; and
controlling the robot lawnmower to circumnavigate the non-lawn feature around the perimeter of the non-lawn feature starting from the direction tangential to the perimeter of the non-lawn feature.

11. The method of claim 1, further comprising:
controlling the robot lawnmower to completely circumnavigate the non-lawn feature around a perimeter of the non-lawn feature; and
detecting that the robot lawnmower has circumnavigated the entirety of the non-lawn feature.

12. The method of claim 11 wherein the detecting that the robot lawnmower has circumnavigated the entirety of the non-lawn feature comprises:
recording an initial orientation of robot lawnmower before controlling the robot lawnmower to circumnavigate the non-lawn feature around the perimeter of the non-lawn feature; and
periodically recording an updated orientation of the robot lawnmower during the circumnavigation of the non-lawn feature;
comparing the updated orientation of the robot lawnmower to the initial orientation of the robot lawnmower, until the comparing indicates that the robot lawnmower has circumnavigated the entirety of the non-lawn feature.

13. The method of claim 12, wherein the initial orientation and the updated orientation correspond to an initial yaw value and an updated yaw value of the robot lawnmower respectively.

14. The method of claim 13, wherein the comparing indicates that the robot lawnmower has circumnavigated the entirety of the non-lawn feature when there is at least a three hundred and sixty degree difference between the initial yaw value and the updated yaw value.

15. The method of claim 14, further comprising:
determining a rotational direction of circumnavigation by comparing the initial orientation of the robot lawnmower to the updated orientation of the robot lawnmower.

16. A robot lawnmower comprising a memory module, one or more sensors, and a processor communicatively coupled to the memory module and the one or more sensors, wherein the processor is configured to perform the method of claim 1.

17. The robot lawnmower of claim 16, wherein the one or more sensors includes a camera configured to capture images of an upcoming path of the robot lawnmower.

18. The robot lawnmower of claim 17, further comprising an inertial measurement unit for calculating a yaw value.

19. A system comprising:
the robot lawnmower of claim 16; and
a charging station for charging the robot lawnmower.
